(19) United States
(12) Patent Application Publication
(10) Pub. No.: US 2007/0141282 A1
(43) Pub. Date: Jun. 21, 2007

(54) Flexible barrier membranes employing poly (hydroxy amino ethers)

(76) Inventors: Yihua Chang, Portland, OR (US); Richard L. Watkins, Portland, OR (US); Jeffrey Stuart Wiggins, Hattiesburg, MS (US)

Correspondence Address: HARNESS, DICKEY & PIERCE, P.L.C., P.O. BOX 828, BLOOMFIELD HILLS, MI, 48303, US

(21) Appl. No.: 11/313,030

(22) Filed: Dec. 20, 2005

(51) Int. Cl. B32B 27/32; B32B 27/40; B32B 1/02

(52) U.S. Cl. 428/35.2; 428/411.1; 428/423.1

(57) ABSTRACT

A multi-layer composite has at least one elastomer layer and at least one barrier layer. In various embodiments, the composite contains at least two elastomer layers alternating with at least two barrier layers. In other embodiments, the composite comprises at least ten alternating barrier and elastomer layers. The barrier layer is made of an amorphous polymer, and is provided in the form of a film. Preferably, the amorphous polymer film has a gas transmittance rate (GTR) of less than 40 cc·mil/m²·day·atm; preferably less than 20 cc·mil/m²·day·atm; measured as nitrogen transmittance at 0% relative humidity at 23° C.

The present invention relates to flexible barrier membranes for cushioning devices. More particularly, the invention relates to a gas filled cushioning device that includes an elastomeric barrier material for selectively controlling the diffusion of gases normally contained in the atmosphere, with the cushioning device being particularly employed in footwear products.

Membranes, and more particularly, membranes useful for containing fluids, including liquids and gases, in a controlled manner, have been employed for years in a wide variety of products ranging from bladders useful in inflatable objects such as vehicle tires and sporting goods; accumulators used on heavy machinery; and cushioning devices useful in footwear. Regardless of the intended use, membranes must generally be flexible, resistant to environmental degradation, and exhibit excellent gas transmission controls. Often, however, flexible materials tend to have an unacceptably low level of resistance to gas permeation. In contrast, materials with an acceptable level of resistance to gas permeation tend to have an unacceptably low level of flexibility.

Known footwear bladders may be made from membranes that are composites or laminates and that include an elastomeric layer and a barrier layer. Elastic materials, or elastomers, which make up the elastomeric layer are generally able to substantially recover their original shape and size after removal of a deforming force even when the part has undergone significant deformation. However, while films making up the barrier layers may be flexed to a certain extent due to their thinness, thermoplastic barrier films do not generally have sufficient elasticity for many applications. The barrier layer tends to crack and leak after repeated cycles of deformation, such as occur during use of an athletic shoe.

For example, U.S. Pat. Nos. 5,952,065 and 5,713,141 to Mitchell et al. describe cushioning devices employing flexible membranes containing an elastomeric layer and at least one layer of a semi-crystalline barrier layer copolymer of ethylene and vinyl alcohol. The use of semi-crystalline barrier layer does away with a requirement for a tie layer or adhesives.

A number of patents describe barrier layers composed of phenoxy resins including poly(hydroxy amino ethers). See for example, U.S. Pat. No. 5,275,853 to Silvis et al; U.S. Pat. No. 5,464,924 to Silvis et al; U.S. Pat. No. 5,686,551 to White et al; U.S. Pat. No. 5,731,094 to Brennan et al; U.S. Pat. No. 5,814,373 to White et al; U.S. Pat. No. 5,834,078 to Cavitt et al; U.S. Pat. No. 5,962,093 to White et al; U.S. Pat. No. 6,051,294 to White et al; and U.S. Pat. No. 5,472,753 to Farha. The patents are directed toward the use of a barrier layer in packaging materials, for example, PET bottles to prevent oxygen diffusion. They have not been employed as a flexible barrier layer.

It would therefore be desirable to provide phenoxy polymers with a combination of physical properties advantageous for use as a flexible barrier layer. It would also be desirable to provide flexible barrier layers that can readily be incorporated into membranes to produce inflatable bladders for such uses as cushioning devices in footwear.

### SUMMARY

The invention provides a multi-layer composite having at least one elastomeric layer and at least one barrier layer. In various embodiments, the composite contains at least two elastomer layers alternating with at least two barrier layers. In other embodiments, the composite comprises at least ten alternating barrier and elastomer layers. The barrier layer is made of an amorphous polymer, and is provided in the form of a film. Preferably, the amorphous polymer film has a gas transmittance rate (GTR) of less than 40 cc·mil/m²·day·atm; preferably less than 20 cc·mil/m²·day·atm; measured as oxygen transmittance at 0% relative humidity and 23° C.

In a preferred embodiment, the multi-layer composites are provided in the form of a flexible barrier that can be formed into a membrane. The membranes can be used to provide inflatable cushioning devices. In one aspect, the cushioning devices are incorporated into the midsoles of footwear, to provide, for example, an athletic shoe with superior cushioning and performance characteristics.

Preferably, the flexible barrier materials contain a captive gas within an interior compartment of the gas-filled membrane for a relatively long period of time. In a preferred embodiment, for example, the gas-filled membrane maintains about 80% or more of the initial inflated gas pressure over a period of two years. In a non-limiting illustration, products inflated initially to a steady state pressure of between 20.0 to 22.0 psi should retain pressure in the range of about 16.0 to 18.0 psi after a period of about two years.

The barrier materials are flexible, relatively soft, compliant, and resistant to fatigue under high cyclical load. The barrier material can withstand high cycle loads without failure, especially when the barrier material has a thickness of between about 5 mils to about 50 mils. The membranes of the present invention may also be processed into various shapes by techniques used in high volume production. Among these desirable techniques known in the art are blow molding, injection molding, vacuum molding, rotary molding, transfer molding, thermoforming, and pressure forming. Membranes of the present invention are also formable by extrusion techniques, such as tubing or sheet extrusion, including extrusion blow molding. They can be welded to form effective seals typically achieved by RF welding or heat sealing.

In various embodiments, the barrier layers are made of a copolymer of an amine and at least one compound containing two epoxy groups. The amine has two hydrogens, each reactive with an epoxy group, and the amines and epoxy compounds are present in close to stoichiometric amounts in the copolymer.

In a preferred embodiment, the barrier layer or layers of the multi-layer composite includes a copolymer formed from the reaction of a difunctional amine and diglycidyl ethers of resorcinol and bisphenol A.

### BRIEF DESCRIPTION OF THE DRAWINGS

FIG. 1 is a side elevational view of an athletic shoe in accordance with the present invention with a portion of the mid-sole cut-a-way to expose a cross-sectional view;

FIG. 2 is a bottom elevational view of the athletic shoe of FIG. 1 with a portion cut-a-way to expose another cross-sectional view;

FIG. 3 is a section view taken along line 3-3 of FIG. 1;

FIG. 4 is a fragmentary side perspective view of one embodiment of a tubular-shaped, two-layer cushioning device in accordance with the present invention;

FIG. 5 is a sectional view taken along line 4-4 of FIG. 4;

FIG. 6 is a fragmentary side perspective view of a second embodiment of a tubular-shaped, three-layer cushioning device in accordance with the present invention;

FIG. 7 is a sectional side view taken along line 6-6 of FIG. 6;

FIG. 8 is a schematic view of composites of the invention.

### DETAILED DESCRIPTION OF THE INVENTION

In various embodiments, the invention provides a multilayer composite, a membrane made of the multilayer composite, a bladder made of the membrane, and a shoe such as an athletic shoe incorporating the bladder. The multilayer composites of the invention are flexible and contain at least one elastomeric layer and at least one barrier layer. The elastomeric layer and the barrier layer are preferably provided in alternating layers to build up a composite with desired properties of flexibility and gas permeability.

In one embodiment, the flexible multilayer composites of the invention contain at least one elastomer layer and at least one barrier layer made of an amorphous polymer. The barrier layer comprising the amorphous polymer has a gas transmission rate of less than 40 cc·mil/m²·atm·day of nitrogen measured at 60% relative humidity and 23° C. and preferably less than 20 cc·mil/m²·atm·day.

In various embodiments, the amorphous polymer is made of a copolymer of an amine and at least one compound with two oxirane groups. The amine has two hydrogens reactive toward the oxirane groups, and the molar ratio of the amine to the compound having two oxirane groups is preferably from about 95:100 to 105:100.

In other embodiments, the invention provides preferred amorphous polymers suitable for providing the barrier layers of the invention. In a preferred embodiment, the amorphous polymer comprises a copolymer of an amine, resorcinol diglycidyl ether, and bisphenol A diglycidyl ether. Non-limiting examples of amines include 1-amino-2-propanol, N, N′-dialkylalkylenediamines, and piperidine.

Flexible barrier films are manufactured or extruded from the amorphous polymers of the invention. The flexible barrier films are then used together with elastomer layers such as thermoplastic polyurethane, discussed further below, to provide the flexible multilayer composites of the invention. The composites comprise at least one barrier film and at least one elastomer layer.

In various embodiments, the composites contain a center barrier layer and two elastomer layers such as thermoplastic polyurethanes attached to the center barrier. The composites alternatively contain further barrier layers and elastomer layers in alternating form. In a preferred embodiment, the composite further comprises two outer regrind layers described further below.

In preferred embodiments, the composites of the invention contain at least two elastomer layers and at least two barrier layers, preferably in alternating form. In various embodiments, the composites contain at least 10 alternating elastomer and barrier layers.

Bladders of the invention are formed from an elastomeric membrane that includes the multilayer composite of the present invention. In one embodiment, the composite of the invention has alternating thin layers of at least one fluid barrier material and at least one structural, elastomeric material. Also contemplated are composites that include layers of different fluid barrier materials and/or layers of different elastomeric materials, all of the different layers being arranged in regular repeating order. Other layers in addition to elastomeric layers and fluid barrier layers that alternate along with them in a regular, repeating order may optionally be included. In one embodiment, the composite has at least about 10 layers. Preferably, the composite has at least about 20 layers, more preferably at least about 30 layers, and still more preferably at least about 50 layers. The composite can have thousands of layers, and the skilled artisan will appreciate that the number of layers will depend upon such factors as the particular materials chosen, thicknesses of each layer, the thickness of the composite, the processing conditions for preparing the individual layers, and the final application of the composite. In various embodiments, the composites have from about 10 to about 1000 layers, more preferably from about 30 to about 1000 and even more preferably from about 50 to about 500 layers.

The average thickness of each individual layer of the fluid barrier material may be as low as a few nanometers to as high as several mils (about 100 microns) thick. Preferably, the individual layers have an average thickness of up to about 0.1 mil (about 2.5 microns). Average thicknesses of about 0.0004 mil (about 0.01 micron) to about 0.1 mil (about 2.5 microns) are particularly preferable. For example, the individual barrier material layers can be, on average, about 0.05 mils (about 1.2 microns). The thinner layers of the fluid barrier layer material improves the ductility of the bladder membrane.

In various embodiments, the fluid barrier layers are composed of amorphous polymers that have a low gas transmission rate (GTR). Amorphous polymers are polymers that are not crystalline in structure. Amorphous polymers exhibit no crystalline x-ray diffraction, or they do not have a crystalline melting point detectable by differential scanning calorimetry. Amorphous polymers of the invention have a gas transmission rate (GTR) less than 20 cc·mil/m²·atm·day, preferably less than 5 cc·mil/m²·atm·day of N₂ measured at 60% r.h, 23° C. Non-limiting examples of suitable amorphous polymers can be selected from the PHAE resins described below.

GTR is expressed as the volume of gas in cubic centimeters passing through a 1 mil (0.001″ or 0.0025 cm) thick film per day, through an area of 1 square meter at a pressure of 1 atmosphere (cc·mil/m²·atm·day). Measurements of GTR are carried out and reported for a specific gas at a designated relative humidity and temperature. The lower the GTR the less is the permeability of the fluid barrier layer to gases. The overall gas transmission through the composites of the invention is reduced as a result of the provision of multiple fluid barrier layers in some embodiments.

The use of the multilayer composites provides for an additive effect of individual layers. The overall GTR is determined by the additive total thickness of the fluid barrier layers. As a result, each individual barrier layer in the composite can be relatively thin. Thin barrier layers are more flexible and less prone to cracking. If any cracking occurs, gas permeability through the composite is hindered by the tortuous path the gas must take from layer to layer. The amorphous polymers of the invention have the further advantage that they are flexible and less prone to cracking than semi-crystalline barrier layers such as polyvinyl alcohol.

In a preferred embodiment, the barrier layers in the composites of the invention are made from phenoxy resins, preferably from polyhydroxy amino ether resins. These are commonly referred to as PHAE.

Preferred PHAE include the reaction product of amines with compounds having epoxy or oxirane groups (as used here, the terms are synonyms). Reaction of the amine and the epoxy compound is preferably carried out at approximate stoichiometrically equivalent levels of amine and epoxy compound. This allows buildup of molecular weight for desired physical properties and viscosity to reach a level of melt viscosity desired for subsequent processing and fabrication steps.

Preferably, the stoichiometric ratio of amine to epoxy compound is from about 90:100 to about 110:100, and more preferably from about 95:100 to about 105:100.

Polymerization can take place in a solvent (e.g. an inert solvent at moderate temperatures such as 150° C.). Non-limiting examples of suitable inert solvents for preparing the polymers include N,N-dimethylformamide, dipropylene glycol methyl ether, dipropylene glycol ethyl ether, phenoxy-2-propanol, and dimethyl acetamide.

Polymerization can also take place in the melt, such as in a twin screw extruder using a gradual temperature profile to first melt the monomers, and then drive the polymerization to afford high molecular weight.

The epoxy-containing compounds preferably contain on average two epoxy groups, and are based on an aromatic ring system. Suitable epoxy-containing compounds are most conveniently prepared by reacting dihydroxyl functional aromatic compounds with epihalohydrin to form glycidyl ethers, preferably diglycidyl ethers. The resulting epoxy-containing compounds are known as diglycidyl ethers of aromatic diols.

Non-limiting examples of diglycidyl ethers of aromatic diols include the diglycidyl ethers of resorcinol, hydroquinone, 4,4′-isopropylidene bisphenol (bisphenol A), 4,4′-dihydroxydiphenylethylmethane, 3,3′-dihydroxydiphenyldiethylmethane, 3,4′-dihydroxydiphenylmethyl-propylmethane, 4,4′-dihydroxydiphenyloxide, 4,4′-dihydroxydiphenylcyanomethane, 4,4′-dihydroxybiphenyl, 4,4′-dihydroxybenzophenone (bisphenol K), 4,4′-dihydroxydiphenyl sulfide, 4,4′-dihydroxydiphenyl sulfone, 2,6-dihydroxynaphthalene, 1,4′-dihydroxy-naphthalene, catechol, 2,2-bis(4-hydroxyphenyl)-acetamide, 2,2-bis(4-hydroxyphenyl)ethanol, 2,2-bis(4-hydroxyphenyl)-N-methylacetarnide, 2,2-bis(4-hydroxyphenyl)-N,N-dimethylacetamide, 3,5-dihydroxyphenylacetamide, 2,4-dihydroxyphenyl-N-(hydroxyethyl)-acetamide, as well as mixtures of one or more of such diglycidyl ethers.

In various embodiments, symmetric and rigid aromatic diols are less preferred, as their presence tends to provide polymers having crystalline or semicrystalline properties and higher Tg, as opposed the desirable amorphous characteristics of a preferred embodiment of the invention.

Examples of the symmetric rigid diols include hydroquinone (1,4-benzenediol), 2,6-napthalenediol, and 1,4-dihydroxynapthalene.

Preferred diglycidyl ethers include the diglycidyl ethers of resorcinol and bisphenol A as well as mixtures thereof. In a preferred embodiment, the diglycidyl ether is a mixture of resorcinol diglycidyl ether and bisphenol A diglycidyl ether, in molar ratios of from 1:9 to 10:0, i.e., in mixtures ranging from 10% resorcinol diglycidyl ether to 100% resorcinol diglycidyl ether, and ranging respectively from 90% bisphenol A diglycidyl ether to 0% bisphenol A diglycidyl ether, with all percentages being mole percent. Preferably, the mole ratio of resorcinol diglycidyl ether to bisphenol A diglycidyl ether is from 90:10 to about 10:90. In a preferred embodiment, the mixture contains from 0 to 75, preferably 10 to 50 mole percent of bisphenol A diglycidyl ether, and 0-75%, preferably 50-100% resorcinol diglycidyl ether.

Amines suitable for making the PHAE of the invention are at least divalent, that is, they contain at least two active hydrogen atoms that can each react with the epoxy group of the preferred diglycidyl ethers. Suitable divalent amines include compounds having one primary amino group, and compounds having two secondary amino groups.

Non-limiting examples of compounds having one primary amino group include, alkylamines and substituted alkylamines, such as ethylamine, butylamine, isopropylamine, hexylamine, and benzylamine. Others include alkanolamines such as 2-aminoethanol, 1-aminopropan-2-ol, 1-aminopropan-3-ol, sec-butanolamine, 2-aminobutanol, 3-aminobutanol, and 4-aminobutanol. Still other amines having one primary amino group include aromatic monoamines and substituted aromatic monoamines, such as aniline and substituted anilines. Examples of substituted anilines include without limitation, 4-methylamidoaniline, 4-methoxyaniline, 4-tert-butylaniline, 3,4-dimethoxyaniline and 3,4-dimethylaniline.

Examples of compounds having two secondary amino groups include, without limitation, piperazine and substituted piperazines, for example 2-methylamidopiperazine and dimethyl piperazine. Others examples include aromatic secondary diamines, such as N,N′-dialkyl-1,4-benzenediamine, N,N′-dialkyl-1,3-benzenediamine, and N,N′-dialkyl-1,2-benzenediamine, as well as the above aromatic secondary diamines with further substitution on the aromatic ring, for example, dialkylaminotoluene. Specific examples include, without limitation N,N′-dimethyl-1,4-diaminobenzene, and N,N′-dimethyltoluenediamine isomers.

Another preferred class of compounds having two secondary amino groups is the N,N′-dialkylalkylenediamines. Examples include, without limitation, N,N′-dimethylethylenediamine, N,N′-dihydroxyethylethylenediamine, N,N′-diisopropylethylenediamine, N,N′-dimethyl-1,2-propylenediamine, N,N′-dimethyl-2,3-butylenediamine, N,N′-dimethyl-1,3-propylenediamine, and so on. Of these, preferred compounds include those where monosubstituted nitrogen atoms are on adjacent carbon atoms of the diamine. Such diamines include ethylenediamine, 1,2-propylenediamine (1,2-diaminopropane) and 2,3-butylene diamine (2,3-diaminobutane).

Specific examples of preferred amines for preparing the barrier layers of the invention include piperazine and N,N′-dimethylethylenediamine.

Materials suitable for forming the elastomeric layers include, without limitation, polyurethane elastomers, including elastomers based on both aromatic and aliphatic isocyanates; flexible polyolefins, including flexible polyethylene and polypropylene homopolymers and copolymers; styrenic thermoplastic elastomers; polyamide elastomers; polyamide-ether elastomers; ester-ether or ester-ester elastomers; flexible ionomers; thermoplastic vulcanizates; flexible poly(vinyl chloride) homopolymers and copolymers; and flexible acrylic polymers. Blends and alloys of the above may also be used, such as, without limitation, like poly(vinyl chloride)-polyurethane alloys.

In a preferred embodiment, the elastomeric layers contain a polyurethane elastomer material such as the so-called thermoplastic polyurethanes. These include polyester-polyurethanes, polyether-polyurethanes, and polycarbonate-polyurethanes. The synthesis of the thermoplastic polyurethane is carried out by reacting one or more polymeric diols, one or more compounds having at least two isocyanate groups, and, optionally, one or more chain extension agents. In a preferred embodiment, a hydroxyl terminated prepolymer is first prepared from the isocyanate compounds and the polymeric diols. Then the prepolymer is reacted with further isocyanate and chain extension compound. Soft segments are provided by the polymeric diol, while hard segments are provided by the chain extension agent.

Non-limiting examples of polymeric diols include polytetrahydrofurans, polyesters, polycaprolactone polyesters, and polyethers of ethylene oxide, propylene oxide, and copolymers including ethylene oxide and propylene oxide. Chain extension compounds, as the term is used herein, are compounds having two or more functional groups reactive with isocyanate groups. A non-limiting example of a chain extension agent is 1,4-butanediol. Preferably the polymeric diol-based polyurethane is substantially linear (i.e., substantially all of the reactants are di-functional). A preferred diisocyanate is diphenylmethane diisocyanate (MDI). Thermoplastic polyurethanes are described, for example, in Bonk et al., U.S. Pat. No. 6,127,026, the disclosure of which is incorporated by reference.

It is desirable under certain applications to include blends of polyurethanes to form the elastomeric layer, such as when susceptibility to hydrolysis is of particular concern. For example, a polyurethane including soft segments of polyether diols or polyester diols formed from the reaction mixture of a carboxylic acid and a diol wherein the repeating units of the reaction product has more than eight carbon atoms can be blended with polyurethanes including polyester diols having repeating units of eight or less carbon atoms or products of branched diols. Preferably, the polyurethanes other than those including polyester diol repeating units having eight or less carbon atoms or with oxygen atoms connected to tertiary carbons will be present in the blends in an amount up to about 30 wt. %, (e.g. 70.0 wt. % polyethylene glycol adipate based polyurethane, 30.0% isophthalate polyester diol based polyurethane). Specific examples of the polyester diols wherein the reaction product has more than eight carbon atoms include poly(ethylene glycol isophthalate), poly(1,4-butanediol isophthalate) and poly(1,6-hexanediol isophthalate).

Non-limiting examples of materials suitable for use as the elastomeric layer include polyamide-ether elastomers marketed under the tradename PEBAX® by Elf Atochem, ester-ether elastomers marketed under the tradename HYTREL® by DuPont, ester-ester and ester-ether elastomers marketed under the tradename ARNITEL® by DSM Engineering, thermoplastic vulcanizates marketed under the tradename SANTOPRENE® by Advanced Elastomeric Systems, elastomeric polyamides marketed under the tradename GRILAMID® by Emser, and elastomeric polyurethanes marketed under the tradename PELLETHANE® by The Dow Chemical Company, Midland, Mich., ELASTOLLAN® polyurethanes marketed by BASF Corporation, Mt. Olive, N.J., TEXIN® and DESMOPAN® polyurethanes marketed by Bayer, MORTHANE® polyurethanes marketed by Huntsman, and ESTANE® polyurethanes marketed by Noveon.

One further feature of the composites of the present invention is the enhanced bonding which can occur between the layers of the elastomeric material and the fluid barrier material. This so-called enhanced bonding is generally accomplished by using materials for both layers that have available functional groups with hydrogen atoms that can participate in hydrogen bonding such as hydrogen atoms in hydroxyl groups or hydrogen atoms attached to nitrogen atoms in polyurethane groups and various receptor groups such as oxygen and nitrogen atoms in the backbone of the PHAE's. Such composites are characterized in that hydrogen bonding is believed to occur between the elastomeric and fluid barrier materials that form the alternating layers. For example, the above described hydrogen bonding is believed to occur when the elastomeric material comprises a polyester diol based polyurethane and the fluid barrier layer includes a polymer selected from the group consisting of co-polymers of amines and epoxide compounds as described above. In addition to the hydrogen bonding, it is theorized that there will also generally be a certain amount of covalent bonding between the layers of the elastomeric first material and the fluid barrier second material if, for example, there are polyurethanes in adjacent layers or if one of the layers includes polyurethane and the adjacent layer includes a barrier material containing such groups as hydroxyls. Still other factors such as orientation forces and induction forces, otherwise known as van der Waals forces, which result from London forces existing between any two molecules and dipole-dipole forces which are present between polar molecules are believed to contribute to the bond strength between contiguous layers of elastomeric material and barrier layer.

The elastomeric and barrier layers of the multilayer polymeric composite typically include various conventional additives such as, without limitation, hydrolytic stabilizers, plasticizers, antioxidants, UV stabilizers, thermal stabilizers, light stabilizers, organic anti-block compounds, colorants (including pigments, dyes, and the like), fungicides, antimicrobials (including bactericides and the like), mold release agents, processing aids, and combinations of these. Examples of hydrolytic stabilizers include two commercially available carbodiimide based hydrolytic stabilizers known as STABAXOL P and STABAXOL P-100, which are available from Rhein Chemie of Trenton, N.J. Other carbodiimide- or polycarbodiimide-based hydrolytic stabilizers or stabilizers based on epoxidized soy bean oil may be useful. The total amount of hydrolytic stabilizer employed will generally be less than 5.0 wt. % of the composition's total.

Plasticizers are included for purposes of increasing the flexibility and durability of the final product as well as facilitating the processing of the material from a resinous form to a membrane or sheet. By way of example, and without intending to be limiting, plasticizers such as those based on butyl benzyl phthalate (which is commercially available, e.g. as Santicizer 160 from Monsanto) have proven to be particularly useful. Regardless of the plasticizer or mixture of plasticizers employed, the total amount of plasticizer, if any, will generally be less than 20.0 wt. % of the total composition.

The alternating layers of the elastomeric polymer and the fluid barrier polymer have their major surfaces aligned substantially parallel to the major surfaces of the composite. There are a sufficient number of layers of the fluid barrier polymer so that the microlayer composite has the desired fluid transmission rate.

Although it is not necessary for all of the layers to be complete layers, that is to extend in the plane of that layer to all edges of the piece, it is desirable for most layers to be substantially complete layers, that is to extend to the edges of the membrane.

The multilayer polymeric composites are formed by at least two different methods. In a first process, they are prepared using a two-layer, three-layer, or five-layer feed block that directs the layered stream into a static mixer or layer multiplier. The static mixer has multiple mixing elements; preferably at least about 5 elements that increases the number of layers geometrically. In a second method, the multilayer polymeric composites of the invention are prepared by providing a first stream comprising discrete layers of polymeric material. A preferred embodiment of this method is described in detail in Schrenk, et al., U.S. Pat. No. 5,094,793, issued Mar. 10, 1992, which is incorporated herein in its entirety by reference. Briefly, the first stream comprising discrete layers can again be formed by directing the molten extrudate from extruders separately containing the elastomeric material and the fluid barrier material into a two-layer, three-layer, or five-layer feed block. The first stream is then divided into a plurality of branch streams, the branch streams are then redirected or repositioned and individually symmetrically expanded and contracted, being finally recombined in an overlapping relationship to form a second stream with a greater number of discrete layers. In addition, protective boundary layers may be incorporated according to the method of Ramanathan et al., U.S. Pat. No. 5,269,995, issued Dec. 14, 1993, which is incorporated herein in its entirety by reference. The protective layers protect the structural and fluid barrier layers from instability and breakup during the layer formation and multiplication. The protective layers are provided by a stream of molten thermoplastic material supplied to the exterior surfaces of the composite stream to form a protective boundary layer at the wall of the coextrusion apparatus. The protective layer may add special optical or physical attributes to the microlayer polymeric composite material, such as special coloration, including metallic coloration obtained by including metallic or other flake pigments in the protective boundary layer.

In various embodiments, the elastomeric membrane of the invention includes the multi-layer polymeric composite, either as an only layer or as one layer in a laminate construction. The membrane is of any convenient length and width for forming the desired footwear bladder or hydraulic accumulator. The average thickness of the multi-layer polymeric composite of the membrane may vary widely such as, for illustration, from about 3 mils (about 75 microns) to about 200 mils (about 0.5 cm). Preferably, the average thickness of the composite is at least about 50 microns, preferably from about 75 microns to about 0.5 cm, more preferably from about 125 microns to about 0.5 cm, and particularly preferably from about 125 microns to about 0.15 cm. When the polymeric composite is to be used to prepare a bladder for footwear it is preferred that the composite have an average thickness of from about 3 mils (about 75 microns) to about 40 mils (about 0.1 cm), while membranes used in hydropneumatic accumulators are usually thicker. In one preferred embodiment the composite is a microlayer polymeric composite having an average thickness of at least about 125 microns.

In various embodiments, the membrane of the invention is formed from a laminate that includes the multi-layer polymeric composite as one or more laminate layers that alternate with elastomeric layers made of polymers selected from those listed above as suitable as the structural material of the microlayer composite. Preferably the alternate layers are polyurethane materials. Any number of layers of the multilayer composite, preferably from one to about five, more preferably one to three are used to alternate with elastomeric layers of the laminate. One preferred membrane of the invention is a laminate that includes at least one layer A of an elastomeric polyurethane and at least one layer B of the multilayer polymeric composite, represented as an A-B laminate. In other preferred embodiments, the membrane is a laminate having layers A-B-A or layers A-B-A-B-A.

When the multilayer composite is used to prepare a laminate, the laminate preferably has an average thickness of from about 3 mils (about 75 microns) to about 200 mils (about 0.5 cm), and preferably it has an average thickness of from about 3 mils (about 75 microns) to about 50 mils (about 0.13 cm). The multilayer composite layer of the laminate is preferably has a thickness from about 0.25 mil (about 6.35 microns) to about 102 mils (2600 microns).

Bladders of the invention are made of an outer membrane and an inner chamber that can hold an inflationary gas. The gases used for initially inflating the elastomeric chambers are preferably resistant to diffusing outwardly from the chambers except at an exceedingly slow rate. In one embodiment, so-called “supergases” are used. Supergases include, without limitation, hexafluoroethane, sulfur hexafluoride, perfluoropropane, perfluorobutane, perfluoropentane, perfluorohexane, perfluoroheptane, octafluorocyclobutane, perfluorocyclobutane, hexafluoropropylene, tetrafluoromethane, monochloropentafluoroethane, 1,2-dichlorotetrafluoroethane; 1,1,2-trichloro-1,2,2-trifluoroethane, chlorotrifluoroethylene, bromotrifluoromethane, and monochlorotrifluoromethane.

The supergases have the following common characteristics: very low solubility coefficients, inert, non-polar, uniform/symmetric, spherical, spheroidal (oblate or prolate), or symmetrically branched molecular shape, non-toxic, non-flammable, non-corrosive to metals, excellent dielectric gases and liquids, high level of electron attachments and capture capability, exhibit remarkably reduced rates of diffusion through all polymers, elastomers and plastics (solid film).

When the so-called supergases are used to initially inflate the bladders, a phenomenon known as diffusion pumping is often observed. In diffusion pumping, nitrogen or other gases from the air diffuse into the bladder until equilibrium is reached between the air outside and inside the bladder. Because the supergas does not diffuse out, the net effect of diffusion pumping is to increase the pressure in the bladder.

It may be desired to avoid the use of supergases, perhaps for economic or environmental reasons. In such a case it is possible to inflate the bladders of the invention with a suitable gas such as nitrogen to a suitable pressure. For example, the inflation pressure may range from 0 psi ambient up to about 100 psi.

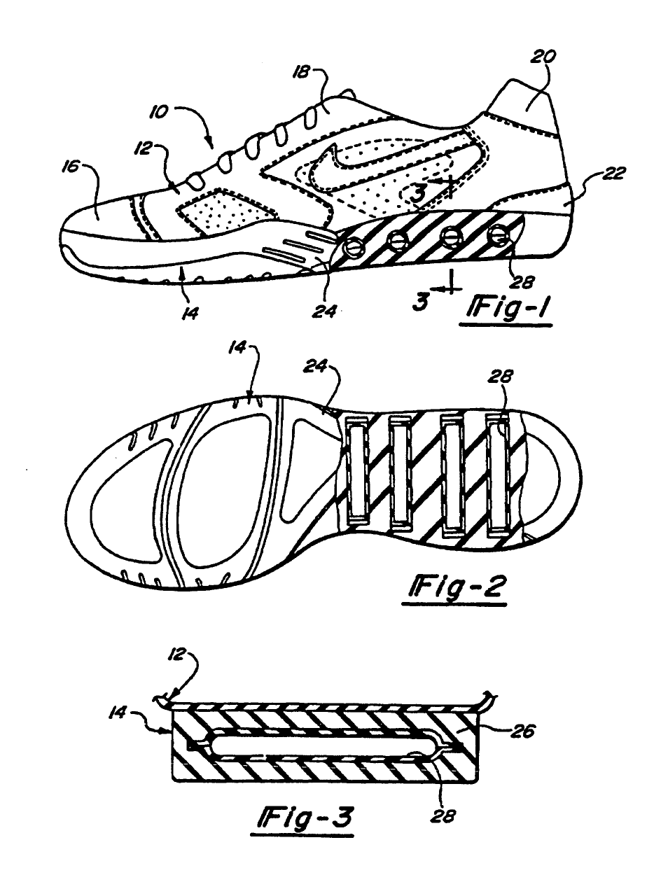

Referring to FIGS. 1-5, there is shown an athletic shoe 10, including a sole structure and a cushioning device otherwise referred to herein as a membrane in accordance with the teachings of the present invention. The shoe 10 includes a shoe upper 12 to which the sole 14 is attached. The shoe upper 12 can be formed from a variety of conventional materials including, but not limited to, leathers, vinyls, nylons and other generally woven fibrous materials. Typically, the shoe upper 12 includes reinforcements located around the toe 16, the lacing eyelets 18, the top of the shoe 20 and along the heel area 22. As with most athletic shoes, the sole 14 extends generally the entire length of the shoe 10 from the toe region 20 through the arch region 24 and back to the heel portion 22.

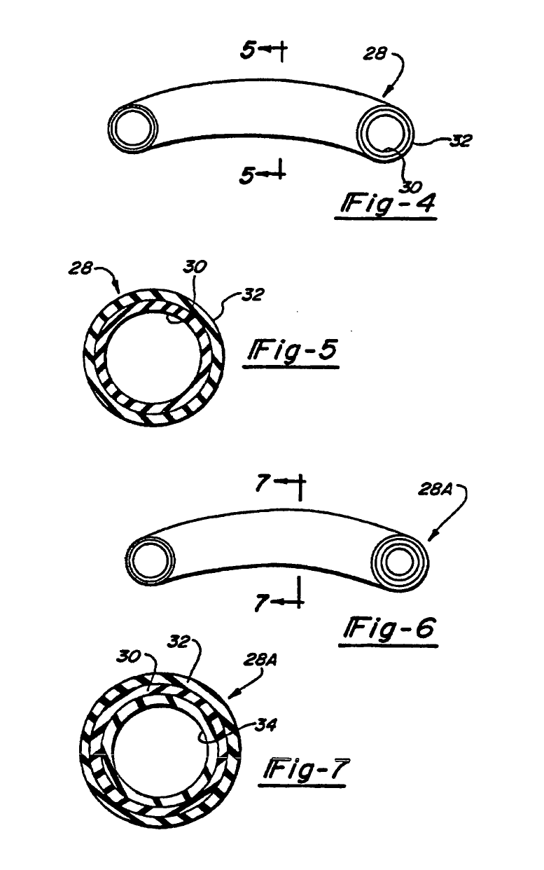

In accordance with the present invention, the sole structure 14 includes one or more membranes 28 preferably disposed in the mid-sole 26 of the sole structure. By way of example, the membranes 28 of the present invention can be formed having various geometries such as a plurality of tubular members positioned in a spaced apart, parallel relationship to each other with the heel region 22 of the mid sole 26. The tubular members 28 are sealed inflatable membranes containing an injected captive gas. More specifically, each of the membranes 28 is formed to include a barrier layer that resists or prevents diffusion of the captive gases. These two membrane layers may be best seen in FIGS. 4 and 5. As previously noted, the membranes 28 of the present invention can be formed in a variety of configurations or shapes.

As shown, the membrane 28 has an A-B composite structure including an outer layer 32 formed of a flexible resilient elastomeric material which preferably is resistant to expansion beyond a predetermined maximum volume for the membrane when subjected to gaseous pressure. The membrane 28 also includes an inner layer 30 formed of a barrier material. In various embodiments, the inner layer 30 comprises a barrier layer as described above or a multilayer polymeric composite laminate layer.

The outer layer 32 preferably is formed of a material or combination of materials which offer superior heat sealing properties, flexural fatigue strength, a suitable modulus of elasticity, tensile and tear strength and abrasion resistance. Among the available materials which offer the cited characteristics, it has been found that thermoplastic elastomers of the urethane variety, otherwise referred to herein as thermoplastic urethane or simply TPU's, are preferred because of their excellent processability. By the term “thermoplastic,” as used herein, is meant that the material is capable of being softened by heating and hardened by cooling through a characteristic temperature range, and can therefore be shaped in to various articles in the softened state via various techniques.

Among the numerous thermoplastic urethanes which are useful in forming the outer layer 32 are urethanes such as Pellethane™, (a trademarked product of The Dow Chemical Company of Midland, Mich.); Elastollan™, (a registered trademark of the BASF Corporation); and ESTANE™. (a registered trademark of Noveon); all of which are either ester or ether based, have proven to be particularly useful. Still other thermoplastic urethanes based on polyesters, polyethers, polycaprolactone and polycarbonate macroglycols can be employed.

As previously noted, the membranes as disclosed herein can be formed by various processing techniques including but not limited to blow molding, injection molding, vacuum molding and heat sealing or RF welding of tubing and sheet extruded film materials. Preferably, the membranes according to the teachings of the present invention are made from films formed by co-extruding layers of thermoplastic urethane material and the layers of amorphous polymers or PHAE polymers in alternating layers having individual thickness described above. Subsequently, after forming the multi-layered film materials, the film materials are heat sealed or welded by RF welding to form the inflatable membranes.

Referring now to FIGS. 6 and 7, an alternative membrane embodiment 28A in the form of an elongated tubular shaped multi-layered component is illustrated. The modified membrane 28A is essentially the same as the composite structure illustrated in FIGS. 1-5 except that a third layer 34 is provided contiguously along the inner surface of the barrier layer 30, such that the barrier layer 30 is sandwiched between the outer layer 32 and innermost layer 34 to form an A-B-A laminate. The innermost layer 34 is also preferably made from a thermoplastic urethane based material. In addition to the benefits of enforced protection against degradation of the barrier layer 30, layer 34 also tends to assist in providing for high quality welds which allows for the three-dimensional shapes of bladders.

The air bladders shown in FIGS. 1-7 are preferably fabricated from multi-layered extruded tubes. Lengths of the coextruded tubing ranging from one foot to coils of up to 5 feet are inflated to a desired initial inflation pressure ranging from 0 psi ambient to 100 psi, preferably in the range of 5 to 50 psi, with a captive gas, preferably nitrogen. Sections of the tubing are RF welded or heat sealed to the desired lengths to define an interior compartment. The individual bladders produced may then be separated by cutting through the welded areas between bladders. It should also be noted that the air bladders can be fabricated with so-called lay flat extruded tubing with the internal geometry being welded into the tube.

In a co-extrusion process, as the thermoplastic urethane and main barrier material (amorphous polymer or PHAE) advance to the exit end of the extruder through individual flow channels, once they near the die-lip exit, the melt streams are combined and arranged to float together in layers typically moving in laminar flow as they enter the die body. Ideally, the materials are combined at a temperature of between about 300° F. to about 465° F. to obtain optimal wetting for maximum adhesion between the contiguous portions of the layers 30, 32 and 34 respectively.

In a highly preferred embodiment, the two thermoplastic urethane layers and the layer of poly(hydroxyl amino ether) are coextruded employing temperatures which are sufficiently elevated to ensure sufficient adhesion between layers thus eliminating the need for an intermediate adhesive or bonding layer.

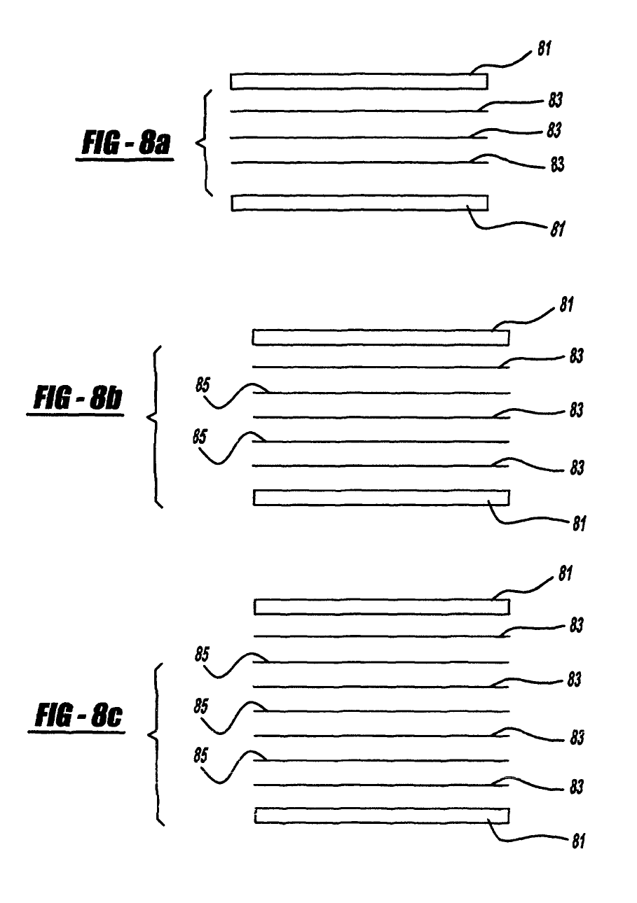

Flexible barriers of the invention take on a variety of configurations. Non-limiting examples are schematically illustrated in FIGS. 8a, 8b, and 8c. In FIG. 8a, an A-B-A laminate 80 is illustrated having two layers of an elastomeric outer layer 81 between which is sandwiched a 3-layer composite including two layers of an elastomeric sheet 83 and one of a fluid barrier layer 85. A similar sandwich device is illustrated in FIG. 8b, except that the multilayer composite contains 2 sheets of the fluid barrier layer 85 and three sheets of the elastomeric layer 83. Similarly, in FIG. 8c, a multilayer composite is shown containing three gas barrier polymer sheets 85 and 4 elastomeric sheets 83. In a preferred embodiment, the gas barrier sheets comprise 1 or more hydroxyl functional copolymers as described above. Also preferably, the elastomeric material is advantageously a thermoplastic polyurethane sheet.

In FIGS. 8a, 8b and 8c, the overall thickness of the one, two, or three layers of the fluid barrier layer is selected so as to obtain the desired gas permeability. Typically the total thickness of the gas barrier sheets in multilayer composites such as illustrated in FIGS. 8a, 8b and 8c is on the order of 1 mil (about 25 micrometers), that is from about 0.1 mil to about 10 mil.

The barriers illustrated in the FIG. 8 optionally contain other structural layers, not shown, typically provided on the outside of layers 81 and 82. Typical structural outside layers include elastomeric materials, such as thermoplastic polyurethane, natural rubber, and synthetic rubbers. In various embodiments, the structural layers are made from regrind materials. The relative thicknesses of the layers and the length of the sheets illustrated in FIGS. 8a, 8b and 8c are given for clarity, and do not necessarily represent actual preferred values.

The various products described in the figures presented are designed to be used as mid-soles for articles of footwear, and particularly in athletic shoes. In such applications, the inflatable membranes may be used in any one of several different embodiments; (1) completely encapsulated in a suitable mid-sole foam; (2) encapsulated only on the top portion of the unit to fill-in and smooth-out the uneven surfaces for added comfort under the foot; (3) encapsulated on the bottom portion to assist attachment of the out-sole; (4) encapsulated on the top and bottom portions but exposing the perimeter sides for cosmetic and marketing reasons; (5) encapsulated on the top and bottom portions but exposing only selected portions of the sides of the unit; (6) encapsulated on the top portion by a molded “Footbed”; and (7) used with no encapsulation foam whatsoever.

While the bladders of the invention have been described for the highly useful applications of cushioning devices for footwear and for accumulators, it should be appreciated that the membranes of the present invention have a broad range of applications, including but not limited to bladders for inflatable objects such as footballs, basketballs, soccer balls, inner tubes; flexible floatation devices such as tubes or rafts; as a component of medical equipment such as catheter balloons; as part of an article of furniture such as chairs and seats, as part of a bicycle or saddle, as part of protective equipment including shin guards and helmets; as a supporting element for articles of furniture and, more particularly, lumbar supports; as part of a prosthetic or orthopedic device; as a portion of a vehicle tire, particularly the outer layer of the tire; and as part of certain recreation equipment such as components of wheels for in-line or roller skates.

The multi-layer composites may be made by a variety of methods known in the art. For example, the barrier layer can be coextruded as described above with the elastomeric layer in the form of a tube or flat sheet. Airbags can be made from the tube through a blow molding process in which the coextruded polymers in the molten state following the extrusion form the desired shape and are then cooled. Bags may also be made by thermal, ultrasonic or radio frequency welding. Airbags can also be made by thermoforming of two flat sheets. The number of barrier layers in the coextruded composite can vary from a single layer to almost unlimited number of layers.

The composite can also be made by dip coating, spray coating, slot coating, and the like. By these methods, the inside, outside, or both of a bag made of an elastomeric material may be coated with a barrier material.

### EXAMPLE 1

Polymers are synthesized from the diglycidyl ethers and amines of examples 1a-1f according to the procedure of Silvis et al., U.S. Pat. No. 5,275,853. Equimolar amounts of the starting diglycidylether and starting amine are heated to about 80° C. to produce an exotherm and an increase in viscosity. The temperature is maintained for an hour, while the reaction mixture is maintained stirrable by periodic additions of a suitable solvent as needed. The Tg is measured by DSC at a heating rate of 20 degree per minute while the gas transmission rate (GTR) is measured at 23° C., 0% RH (relative humidity) for examples 1a, 1b, 1c, 1e, and 1f, or 60% RH for example 1d, and expressed as cc·mil/m²·atm·day, where the gas is oxygen. For example 1d measured at 60% relative humidity, it is expected the GTR at 0% relative humidity would be less than the 19.6 value given in the Table.

| | Starting | | Tg of | |
|---|---|---|---|---|
| Example | Diglycidylether | Starting Amine | Polymer | O₂TR |
| 1a | bisphenol A | 2-aminopropanol | 61 | 480 |
| 1b | 50/50 resorcinol/ | 2-aminopropanol | 59 | 9.2 |
| | bisphenol A | | | |
| 1c | bisphenol A | N,N′- | 43 | 16.8 |
| | | dimethylethylene- | | |
| | | diamine | | |
| 1d | 50/50 resorcinol/ | N,N′- | 34 | 19.6 |
| | bisphenol A | dimethylethylene- | | |
| | | diamine | | |
| 1e | resorcinol | N,N′- | 24 | 19.2 |
| | | dimethylethylene- | | |
| | | diamine | | |
| 1f | 75/25 catechol/ | piperazine | 81 | 7.2 |
| | bisphenol A | | | |

Examples 1a-1e of the table are amorphous polymers, while Example 1f is semi-crystalline. Films are prepared by melt extruding or hot pressing the polymers of Examples 1a-1f.

### EXAMPLE 2

A PHAE containing equal molar amounts of resorcinol and N,N-dimethylethylene diamine is dissolved in an acid solution. TPU bags are coated with such solution, and then dried. Next, a layer of TPU is placed on the coating for protection purpose by dip coating. The bags are KIM tested to 60,000 cycles at ambient temperature, and the GTR of the control and tested bags is measured with a Mocon unit using dry nitrogen gas. The control bags have an average GTR of 8.1 cc/m²·day·atm for nitrogen. The GTR of the tested bags is 9.7 cc/m²·day·atm. The total wall thickness of the bags is about 30 mils. For the same bag without the coating, the oxygen transmission rate is about 80-100 cc/m²·day·atm.

We claim:

1. A flexible multilayer composite, comprising
at least one elastomer layer, and
at least one barrier layer comprising an amorphous polymer,
wherein the barrier layer has a gas transmission rate less than 40 cc·mil/m²·atm·day of nitrogen measured at 23° C., 0% relative humidity.

2. A composite according to claim 1, wherein the gas transmission rate is less than 20 cc·mil/m²·atm·day.

3. A composite according to claim 1, comprising two or more elastomer layers alternating with two or more barrier layers.

4. A composite according to claim 1, comprising ten or more elastomer layers alternating with ten or more barrier layers.

5. A composite according to claim 1, wherein the elastomer layer comprises thermoplastic polyurethane.

6. A composite according to claim 5 wherein the thermoplastic polyurethane is an aromatic thermoplastic polyurethane.

7. A bladder comprising a membrane enclosing a chamber for an inflationary gas, wherein the membrane comprises a flexible multilayer composite according to claim 1.

8. An athletic shoe comprising a bladder according to claim 7.

9. A flexible multilayer composite, comprising
at least one elastomer layer, and,
at least one barrier layer comprising a copolymer of an amine and at least one compound with two oxirane groups, wherein
the amine has two hydrogens reactive toward the oxirane groups, and
the molar ratio of the amine to the compound having two oxirane groups is from 95:100 to 105:100.

10. A flexible multilayer composite according to claim 9, comprising at least two elastomer layers and at least two barrier layers.

11. A flexible multilayer composite according to claim 9, comprising at least ten elastomer layers and at least ten barrier layers.

12. A composite according to claim 9, wherein the elastomer layer comprises thermoplastic polyurethane.

13. A composite according to claim 9, comprising
a center barrier layer;
two thermoplastic polyurethane layers attached to the center barrier, and
two outer regrind thermoplastic polyurethane layers.

14. A composite according to claim 9, wherein the amine comprises N,N′-dialkylalkylenediamine.

15. A composite according to claim 9, wherein the amine comprises piperidine.

16. A composite according to claim 9, wherein the compound with two oxirane groups is selected from the group consisting of resorcinol diglycidyl ether, bisphenol A diglycidyl ether, and mixtures thereof.

17. A cushioning device comprising a membrane, wherein the membrane comprises a flexible multilayer composite according to claim 9.

18. A bladder comprising a multiple layer composite closed membrane, wherein the membrane comprises:
at least one elastomer layer; and
at least one flexible barrier layer comprising a copolymer of an amine and a compound with two oxirane groups, wherein the amine has two hydrogens reactive with the oxirane groups, and wherein a molar ratio of amine to compound with two oxirane groups is from 95:100 to 100:105.

19. A bladder according to claim 18, wherein the compound with two oxirane groups is selected from the group consisting of resorcinol diglycidyl ether, bisphenol A diglycidyl ether, and mixtures thereof.

20. A bladder according to claim 18, wherein the elastomeric layer is selected from the group consisting of aromatic TPU, aliphatic TPU, ethylene-propylene copolymers, polyether-polyamide block copolymers, polyester-polyamide block copolymers, polyester-polyester block copolymers, polyester-polyether block copolymers, styrene-olefin random and block copolymers, metallocene polyolefins, and mixtures thereof.

21. A bladder according to claim 18, wherein the barrier layer comprises a copolymer of an amine, the diglycidyl ether of resorcinol, and the diglycidyl ether of bisphenol A.

22. A shoe comprising a midsole, wherein the midsole contains one or more bladders according to claim 18.

23. A copolymer of an amine, resorcinol diglycidyl ether, and bisphenol A diglycidyl ether, wherein the amine has two hydrogens reactive toward the diglycidyl ethers, and wherein the molar ratio of the amine to the diglycidyl ethers in the copolymer is from 95:100 to 105:100.
